(19) United States
(12) Patent Application Publication
(10) Pub. No.: US 2024/0254996 A1
(43) Pub. Date: Aug. 1, 2024

(54) PUMP MONITORING SYSTEM AND METHOD

(71) Applicant: Edwards Limited, Burgess Hill, Sussex (GB)

(72) Inventors: Michael Simmonds, Burgess Hill, Sussex (GB); Alexander James Patey, Burgess Hill, Sussex (GB); Christopher Miles, Burgess Hill, Sussex (GB)

(21) Appl. No.: 18/561,542

(22) PCT Filed: May 19, 2022
(86) PCT No.: PCT/GB2022/051255

§ 371 Date: Nov. 16, 2023

(30) Foreign Application Priority Data
May 21, 2021 (GB) 2107289.7

(51) Int. Cl. F04D 27/00; F04D 19/04; F04D 29/66

(52) U.S. Cl. CPC F04D 27/001; F04D 19/042; F04D 29/661; F05D 2270/333; F05D 2270/81

(57) ABSTRACT

A pump monitoring system includes a controller and a microphone for detecting sound waves. The controller is configured to receive an audio signal from the microphone representing sound waves generated by the vacuum pump. The controller processes the received audio signal to generate a frequency domain representation of the audio signal. The frequency domain representation of the audio signal is analysed to identify at least one fault condition frequency component indicative of a fault condition. A fault condition signal is output to identify the fault condition in dependence on the identification of the at least one fault condition frequency component. In a further embodiment, the pump monitoring system comprises a vibration sensor for detecting vibrations. The present invention also relate to a vacuum pump; a method of monitoring a vacuum pump; and a nontransitory computer-readable medium.

### CROSS-REFERENCE OF RELATED APPLICATION

This application is a Section 371 National Stage Application of International Application No. PCT/GB2022/051255, filed May 19, 2022, and published as WO 2022/243682A1 on Nov. 24, 2022, the content of which is hereby incorporated by reference in its entirety and which claims priority of British Application No. 2107289.7, filed May 21, 2021.

### FIELD

The present disclosure relates to a pump monitoring system and method. Aspects of the invention relate to a pump monitoring system and method for identifying a fault condition in a pump. The pump monitoring system and method described herein have particular application in relation to the monitoring of a vacuum pump.

### BACKGROUND

Vacuum pumps may develop a fault condition, for example due to bearing wear. If not identified, the fault condition may develop and result in damage to the vacuum pump.

It is known from US 2019/0383296 to provide a vacuum pump with an acceleration sensor. The vibration data output from the acceleration sensor is processed to identify bearing vibration frequencies. An alarm is generated when the acceleration values for the monitored bearing vibration frequencies reach or exceed a threshold. A challenge associated with this arrangement is the need to isolate the acceleration sensor, for example to control resonant frequencies in the mounting assembly to prevent interference with the measurements.

It is an aim of the present invention to address one or more of the disadvantages associated with the prior art.

The discussion above is merely provided for general background information and is not intended to be used as an aid in determining the scope of the claimed subject matter. The claimed subject matter is not limited to implementations that solve any or all disadvantages noted in the background.

### SUMMARY

Aspects and embodiments of the invention provide a pump monitoring system; a vacuum pump comprising a pump monitoring system; a method of monitoring a vacuum pump; and a non-transitory computer-readable medium as claimed in the appended claims.

According to an aspect of the present invention there is provided a pump monitoring system for identifying a fault condition in a vacuum pump; the pump monitoring system comprising a controller and a microphone for detecting sound waves; the controller being configured to:
receive an audio signal from the microphone representing sound waves generated by the vacuum pump;
process the received audio signal to generate a frequency domain representation of the audio signal;
analyse the frequency domain representation of the audio signal to identify at least one fault condition frequency component indicative of a fault condition; and
output a fault condition signal to identify the fault condition in dependence on the identification of the at least one fault condition frequency component. The pump monitoring system can be configured to identify the fault condition in the vacuum pump. The pump monitoring system is operable to identify a fault condition by monitoring the sound emitted by the vacuum pump when it is operating. It has been determined that the fault conditions of the vacuum pump have an identifiable audio signature. At least in certain embodiments, the pump monitoring system is operable to identify the audio signature associated with one or more fault condition. The fault condition frequency component may be predefined in dependence on the audio signature associated with a known fault condition. The controller is configured to convert the sound waves to a frequency domain to enable identification of the fault condition frequency component. The fault condition is associated with the fault condition frequency component. Different fault conditions may be associated with different fault condition frequency components. The controller is configured to identify the at least one fault condition frequency component which is indicative of an associated fault condition. The pump monitoring system outputs the fault condition signal to provide a notification or an alert that a fault condition has been identified. In certain embodiments, the vacuum pump may be deactivated in dependence on the fault condition signal. This may enable maintenance or servicing to be performed to prevent the fault developing. Alternatively, servicing or maintenance may be scheduled in dependence on the fault condition signal.

At least in certain embodiments, the or each fault condition frequency component comprises or consists of an identifiable feature or element in the frequency domain representation of the audio signal. The or each fault condition frequency component may, for example, comprise or consist of a peak or a spike in the frequency domain representation of the audio signal. The term “frequency component identifier” is used herein to describe a feature or element which is suitable for identifying a particular frequency component. The fault condition frequency component may each comprise one or more frequency component identifier which can be identified by the controller.

The controller may be configured to identify a plurality of the fault condition frequency components. The controller may be configured to analyse the frequency domain representation of the audio signal to identify one or more of the plurality of the fault condition frequency components. The fault condition frequency components may each relate to an associated fault condition. The controller may be configured to identify a first fault condition frequency component. The first fault condition may be indicative of a first fault condition. The controller may be configured to identify a second fault condition frequency component. The second fault condition may be indicative of a second fault condition. The first and second fault conditions may be different from each other.

The pump monitoring system may detect a fault condition in the vacuum pump in dependence on the identification of the fault condition frequency component. At least in certain embodiments, the pump monitoring system may identify the nature or form of the fault condition. For example, the pump monitoring system may determine that the fault condition relates to a particular component of the vacuum pump. This determination may, for example, be made in dependence on a frequency at which the fault condition frequency component occurs within the frequency domain representation of the audio signal. The controller may be configured to characterise the fault condition in dependence on the frequency at which the fault condition frequency component occurs within the frequency domain representation of the audio signal. The fault condition signal may identify the particular fault condition.

It will be understood that the controller may identify more than one fault condition in the vacuum pump. Different combinations of fault conditions may affect the frequency component identifier associated with each fault condition frequency components. The controller may be configured to identify any such changes when two or more fault conditions are identified concurrently.

The controller may comprise at least one electronic processor configured to process the audio signal received from the microphone. The at least one electronic processor may be configured to transform the audio signal from the time domain to the frequency domain. The at least one electronic processor may comprise at least one electrical input for receiving the audio signal from the microphone. The at least one electronic processor may comprise at least one electrical output for outputting a fault condition signal in dependence on the identification of the fault condition.

The controller may be configured to determine an operating speed of the vacuum pump. The controller may be configured to identify the at least one fault condition frequency component in dependence on the determined operating speed of the vacuum pump.

The controller may be configured to identify the or each fault condition frequency component during steady-state operation of the vacuum pump.

The controller may be configured to identify the at least one fault condition frequency component as the operating speed of the vacuum pump increases or decreases. An increase in the operating speed of the vacuum pump may occur during a ramp-up process. A decrease in the operating speed of the vacuum pump may occur during a ramp-down process. The controller may be configured to identify changes in one or more frequency component identifier defining the or each fault condition frequency component as the operating speed of the vacuum pump increases or decreases. For example, the controller may be configured to identify an increase or a decrease in a frequency of the at least one fault condition frequency component in dependence on a change in the operating speed of the vacuum pump.

It has been recognised that at certain operating speeds, the sound waves generated by the microphone may comprise high levels of noise or interference. These may, for example, be caused by vibrations occurring at a resonant frequency of one or more component in the vacuum pump. At these operating speeds, the controller may not prove as effective in identifying the at least one fault condition frequency component. The controller may be configured to inhibit or suppress identification of the at least one fault condition frequency component at one or more operating speed, or within one or more operating speed range. The one or more operating speed and/or the one or more operating speed range may be predefined.

Alternatively, or in addition, the controller may be configured to require identification of the at least one fault condition frequency component for a predetermined time period. Alternatively, or in addition, the controller may be configured to require identification of the at least one fault condition frequency component at a predetermined operating speed, or over a predetermined operating speed range. The controller may be configured to output a fault condition signal to identify the fault condition only when one or more of these conditions is satisfied.

The controller may be configured to output a request to change the operating speed of the vacuum pump. The controller may be configured to monitor a change in the fault condition frequency component in dependence on the change in the operating speed of the vacuum pump. By way of example, a change in the operating speed of the vacuum pump may result in a corresponding change in a frequency component identifier which identifies the fault condition frequency component. The controller may be configured to confirm the identification of the fault condition frequency component in dependence on a detected change in the at least one fault condition frequency component. The controller may be configured to output a fault condition signal to identify the fault condition in dependence on the confirmed identification of the at least one fault condition frequency component. By requesting changes in the operating speed of the vacuum pump, the controller can isolate a vacuum pump, for example to differentiate between two or more vacuum pumps that may be operating concurrently. It is believed that this control strategy may be patentable independently. Moreover, it is understood that this technique may be applicable to monitoring systems employing sensors other than microphones, such as a vibration sensor or an acceleration sensor.

The controller may request an increase or a decrease in the operating speed of the vacuum pump. The controller may request a target operating speed of the vacuum pump. Any changes in the operation speed of the vacuum pump may be performed within predefined operating ranges, for example to ensure that the operating speed does not exceed a predefined limit.

The controller may be configured to determine an operating load on the vacuum pump. The at least one fault condition frequency component may be identified in dependence on the operating load of the vacuum pump. The at least one fault condition frequency component may be defined in dependence on the operating load on the vacuum pump. The operating load may comprise one or more of the following: a gaseous load caused by the gas pressure in the vacuum pump; a thermal load caused by an operating temperature of the vacuum pump; and an orientation load caused by the orientation of the vacuum pump. The operating load may be determined by monitoring operation of the vacuum pump, for example in dependence on one or more of the following: a measured electrical load, a measured operating pressure and an operating temperature.

The or each fault condition frequency component may comprise one or more frequency component identifier. The or each frequency component identifier may be identifiable independently to enable identification of an associated fault condition frequency component. Alternatively, a combination of a plurality of the frequency component identifiers may be identified to enable identification of an associated fault condition frequency component. The analysis of the frequency domain representation to identify a fault condition frequency component may comprise identifying a frequency component having the one or more frequency component identifier. The controller may be configured to identify the or each fault condition frequency component in dependence on the identification of the one or more frequency component identifier in the frequency domain representation. The controller may be configured to identify the or each fault condition frequency component in dependence on the presence or absence of the one or more frequency component identifier in the frequency domain representation of the audio signal. The one or more frequency component identifier may be predefined.

A first fault condition frequency component may comprise one or more frequency component identifier having a first value. A second fault condition frequency component may comprise one or more frequency component identifier having a second value. The one or more first value and the one or more second value may be different from each other. The controller may differentiate between the first and second fault condition frequency components in dependence on the first and second values.

The one or more frequency component identifier may comprise a frequency or a frequency range of the or each fault condition frequency component. The frequency may comprise a discrete frequency. The controller may identify the fault condition frequency component in dependence on identification of a frequency component occurring at the discrete frequency. The frequency range may comprise a first frequency value and/or a second frequency value. The frequency range may be greater than the first frequency value; and/or less than the second frequency value. The controller may identify the fault condition frequency component in dependence on identification of a frequency component occurring within the frequency range.

The one or more frequency component identifier may comprise a magnitude (amplitude) or a magnitude (amplitude) range of the or each fault condition frequency component. The or each fault condition frequency component may comprise a magnitude value. The controller may be configured to identify the or each fault condition frequency component by identifying a frequency component in the frequency domain representation of the audio signal which has a magnitude substantially equal to the magnitude value. The controller may be configured to identify the or each fault condition frequency component by identifying a frequency component in the frequency domain representation of the audio signal which has a magnitude greater than the magnitude value. The or each fault condition frequency component may comprise a magnitude range. The controller may be configured to identify the or each fault condition frequency component by identifying a frequency component in the frequency domain representation of the audio signal which has a magnitude within the magnitude range.

The one or more frequency component identifier may be defined with respect to an operating speed of the vacuum pump. The controller may be configured to determine an operating speed of the vacuum pump. The controller may be configured to identify the at least one frequency component identifier in the frequency domain representation in dependence on the operating speed of the vacuum pump.

The fault condition may develop into a failure condition. At least in certain embodiments, the pump monitoring system facilitates early identification of the fault condition. This may reduce or avoid damage to the vacuum pump.

The microphone may be mounted internally or externally of the vacuum pump. The microphone may be always on or may be selectively activated and deactivated. For example, the microphone may be selectively disabled during venting.

The controller may be configured to receive a temperature signal from a temperature sensor; and/or a pressure signal from a pressure sensor. The identification of the fault condition may be performed in dependence on the temperature signal and/or the pressure signal.

The pump monitoring system may receive more than one audio signal, for example from a plurality of microphones which may be spaced apart from each other. The controller may be configured to analyse the audio signals received form the plurality of microphones. The controller may process the received audio signals to generate frequency domain representation of each audio signal. The controller may compare the frequency domain representation of the audio signals.

According to a further aspect of the present invention there is provided a pump monitoring system for identifying a fault condition in a vacuum pump; the pump monitoring system comprising a controller and a vibration sensor for detecting vibrations; the controller being configured to:
receive a vibration signal from the vibration sensor representing vibrations generated by the vacuum pump;
process the received vibration signal to generate a frequency domain representation of the vibration signal;
analyse the frequency domain representation of the vibration signal to identify a fault condition frequency component indicative of a fault condition;
output a request to change an operating speed of the vacuum pump and detect a change in the at least one fault condition frequency component in dependence on the change in the operating speed of the vacuum pump;
confirm the identification of the fault condition frequency component in dependence on the detected change in the at least one fault condition frequency component; and
output a fault condition signal to identify the fault condition in dependence on the confirmed identification of the at least one fault condition frequency component. The vibration sensor may, for example, comprise an accelerometer. The vibration sensor may be fixedly mounted to the vacuum pump. The vibration sensor may, for example, be mounted to a pump housing. Alternatively, the vibration sensor may be provided in a pump controller, for example in a pump controller housing. The processing applied to the vibration signal may be the same as the techniques described herein in relation to the audio signal generated by the microphone. By requesting a change in the operating speed of the vacuum pump, the pump monitoring system can differentiate between different vacuum pumps, for example to isolate a fault condition. The pump monitoring system may receive more than one vibration signal, for example from a plurality of vibration sensors which may be spaced apart from each other.

The controller may request an increase or a decrease in the operating speed of the vacuum pump. The controller may request a target operating speed of the vacuum pump. Any changes in the operation speed of the vacuum pump may be performed within predefined operating ranges, for example to ensure that the operating speed does not exceed a predefined limit.

The pump monitoring system is operable to identify a fault condition by monitoring the vibrations generated by the vacuum pump when it is operating. The fault conditions of the vacuum pump have an identifiable vibration signature. At least in certain embodiments, the pump monitoring system is operable to identify the vibration signature associated with one or more fault condition. The fault condition frequency component may be predefined in dependence on the vibration signature associated with a known fault condition. The controller is configured to convert the vibration signal to a frequency domain to enable identification of the fault condition frequency component. The fault condition is associated with the fault condition frequency component. Different fault conditions may be associated with different fault condition frequency components. The controller is configured to identify the at least one fault condition frequency component which is indicative of an associated fault condition. The pump monitoring system outputs the fault condition signal to provide a notification or an alert that a fault condition has been identified.

The vacuum pump may be a turbomolecular pump.

According to a further aspect of the present invention there is provided a vacuum pump comprising a pump monitoring system as described herein.

According to a further aspect of the present invention there is provided a method of identifying a fault condition in a vacuum pump; the method comprising:
receive an audio signal representing sound waves generated by the vacuum pump;
converting the audio signal to a frequency domain;
analysing the frequency domain to identify at least one fault condition frequency component indicative of a fault condition; and
identifying the fault condition in dependence on the identification of the at least one fault condition frequency component.

The method may comprise determining an operating speed of the vacuum pump. The at least one fault condition frequency component may be identified in dependence on the determined operating speed of the vacuum pump.

The method may comprise identifying the at least one fault condition frequency component during steady-state operation of the vacuum pump.

The method may comprise identifying the at least one fault condition frequency component as the operating speed of the vacuum pump increases or decreases.

The method may comprise changing the operating speed of the vacuum pump. The method may comprise monitoring changes in the at least one fault condition frequency component as the operating speed of the vacuum pump changes.

The method may comprise determining an operating load on the vacuum pump. The at least one fault condition frequency component may be identified in dependence on the operating load of the vacuum pump.

The at least one fault condition frequency component may comprise one or more frequency component identifier. The one or more frequency component identifier may be predefined. The method may comprise identifying the at least one fault condition frequency component in dependence on the identification of the at least one frequency component identifier in the frequency domain representation.

The one or more frequency component identifier may comprise a frequency of the or each fault condition frequency component. Alternatively, or in addition, the one or more frequency component identifier may comprise a frequency range of the or each fault condition frequency component. The frequency range may comprise a lower frequency value and/or an upper frequency value.

The one or more frequency component identifier may comprise a magnitude of the or each fault condition frequency component. Alternatively, or in addition, the one or more frequency component identifier may comprise a magnitude range of the or each fault condition frequency component. The magnitude range may comprise a lower magnitude value and/or an upper magnitude value.

The one or more frequency component identifier may be defined with respect to an operating speed of the vacuum pump.

The method may comprise receiving more than one audio signal, for example from a plurality of microphones which may be spaced apart from each other. The method may comprise analysing the plurality of audio signals. The audio signals may be processed to generate frequency domain representations of each audio signal. The method may comprise comparing the frequency domain representation of the audio signals.

According to further aspects of the present invention there is provided a method of identifying a fault condition in a vacuum pump; the method comprising:
receiving a vibration signal from a vibration sensor representing vibrations generated by the vacuum pump;
transform the vibration signal to a frequency domain representation of the vibration signal;
analyse the frequency domain representation of the vibration signal to identify a fault condition frequency component indicative of a fault condition;
output a request to change an operating speed of the vacuum pump and detect a change in the at least one fault condition frequency component in dependence on the change in the operating speed of the vacuum pump;
confirm the identification of the fault condition frequency component in dependence on the detected change in the at least one fault condition frequency component; and
output a fault condition signal to identify the fault condition in dependence on the confirmed identification of the at least one fault condition frequency component. The method may comprise receiving more than one vibration signal, for example from a plurality of vibration sensors which may be spaced apart from each other.

According to a further aspect of the present invention there is provided a non-transitory computer-readable medium having a set of instructions stored therein which, when executed, cause a processor to perform the method described herein.

Any control unit or controller described herein may suitably comprise a computational device having one or more electronic processors. The system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller or control unit, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. The control unit or controller may be implemented in software run on one or more processors. One or more other control unit or controller may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

One or more embodiments of the invention will now be described, by way of example only, with reference to the accompanying drawings, in which:

FIG. 1 shows a schematic representation of a vacuum pump and a pump monitoring system in accordance with an embodiment of the present invention;

FIG. 2 shows a schematic representation of a controller of the pump monitoring system 1 shown in FIG. 1;

FIG. 3 shows a graph showing a frequency domain representation of the sound waves emitted by a vacuum pump;

FIG. 4 shows a first block diagram showing the operation of the pump monitoring system according to an embodiment of the present invention;

FIG. 5 shows a second block diagram showing the operation of the pump monitoring system according to a variant of the embodiment of the present invention;

FIG. 6 a schematic representation of a vacuum pump and a pump monitoring system in accordance with a further embodiment of the present invention; and

FIG. 7 shows a third block diagram showing the operation of the pump monitoring system according to the embodiment shown in FIG. 6.

### DETAILED DESCRIPTION

A pump monitoring system 1 in accordance with an embodiment of the present invention is described herein with reference to the accompanying Figures. The pump monitoring system 1 is configured to identify one or more fault condition of the vacuum pump 3. The one or more fault condition each have a characteristic audio signature which is identifiable by the pump monitoring system 1. The pump monitoring system 1 generates a fault condition notification in dependence on identification of an audio signature(s) indicative of a fault condition.

The pump monitoring system 1 is configured to monitor operation of a vacuum pump 3. In particular, the pump monitoring system 1 is configured to identify one or more fault condition in the vacuum pump 3. At least in certain embodiments, the pump monitoring system 1 can provide early identification of the fault condition. This may enable maintenance action or repairs to be performed to prevent the fault developing which may otherwise result in a failure condition. The early identification of the fault condition may facilitate scheduling of maintenance on the vacuum pump 3.

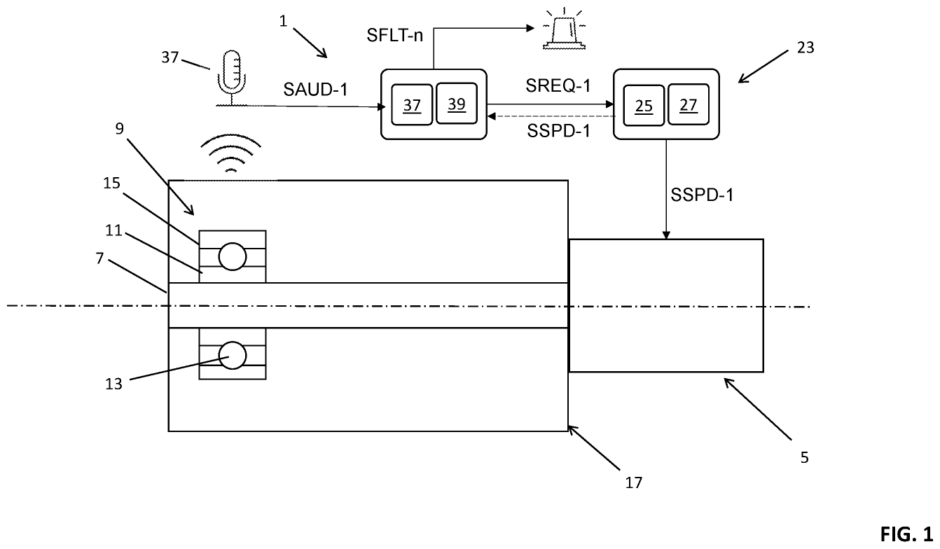

A schematic representation of the vacuum pump 3 is shown in FIG. 1. The vacuum pump 3 is operative to pump process gases, for example associated with semiconductor etching processes and chemical vapour deposition (CVD) processes. The vacuum pump 3 in the present embodiment comprises a turbomolecular pump. The turbomolecular pump comprises a multistage axial-flow turbine comprising high speed rotating blades for compressing a gas. It will be understood that the pump monitoring system 1 may be configured for operation with different types of pumps. The vacuum pump 3 comprises a drive motor 5 operative to rotate a drive shaft 7. The drive shaft 7 is supported by at least one bearing assembly 9 comprising an inner race 11, an outer race 13; a plurality of bearing (rolling) elements 15 disposed between the inner and outer races 11, 13; and a bearing cage (not shown) for holding the bearing elements 15. The bearing cage may be referred to as a bearing separator or bearing retainer. The bearing elements 15 may, for example, comprise ball bearings. The inner race 11 is fixed to and rotates with the drive shaft 7. The outer race 13 is fixedly mounted to a bearing or pump housing (denoted generally by the reference numeral 17). As described herein, the pump monitoring system 1 is operative to identify fault conditions associated with the drive shaft 7 and/or the bearing assembly 9. The pump monitoring system 1 may identify an imbalance in the drive shaft 7, for example caused by the accumulation of deposits from the process gas. The pump monitoring system 1 may identify a fault condition in the bearing assembly 9 caused by wear. In certain embodiments, the pump monitoring system 1 may differentiate between wear on one or more of the inner race 11, the outer race 13 and the bearing elements 15.

A pump controller 23 is provided for controlling operation of the vacuum pump 3. The pump controller 23 comprises an electronic processor 25 and a system memory 27. The electronic processor 25 is configured to output a speed control signal SSPD-1 to control an operating speed of the drive motor 5. As described herein, the pump monitoring system 1 and the pump controller 23 are configured to communicate with each other. In particular, the speed control signal SSPD-1 may be output from the pump controller 23 to the pump monitoring system 1. The pump monitoring system 1 is configured to determine the current (instantaneous) operating speed of the drive motor 5, for example in dependence on the speed control signal SSPD-1. Alternatively, or in addition, a rotational sensor (not shown) may be provided to measure the operating speed of the drive motor 5. A speed signal may be output from the rotational sensor to the pump monitoring system 1 and/or the pump controller 23. The pump controller 23 may output other operating parameters to the pump monitoring system 1, for example a load signal indicating an operating load of the vacuum pump 3 and/or an operating mode signal indicating an operating mode of the vacuum pump 3. In the present embodiment, the pump monitoring system 1 and the pump controller 23 are separate from each other. In a variant, the pump monitoring system 1 and the pump controller 23 may be combined with each other. For example, the functions of the pump monitoring system 1 may be incorporated into the pump controller 23.

The pump monitoring system 1 comprises a monitoring system controller 35 and a microphone 37 for detecting sound waves. The microphone 37 is configured to detect sound waves generated by the vacuum pump 3. The sound waves propagate through air as an acoustic wave and are detected by the microphone 37. The microphone 37 in the present embodiment is configured to detect sound waves in the audio frequency range (in the range from approximately 20 Hz and 20 kHz). Alternatively, or in addition, the microphone 37 may detect non-audio sound waves, for example ultrasonic sound. The microphone 37 is configured to generate an audio signal SAUD-1 representing the sound waves. The audio signal SAUD-1 is output to the monitoring system controller 35 to be processed. The microphone 37 is disposed proximal to the vacuum pump 3. The vacuum pump 3 is in a fixed location which is spaced apart from an exterior of the vacuum pump 3. The microphone 37 could be mounted to the vacuum pump 3. A vibration damper may be provided to help isolate the microphone 37.

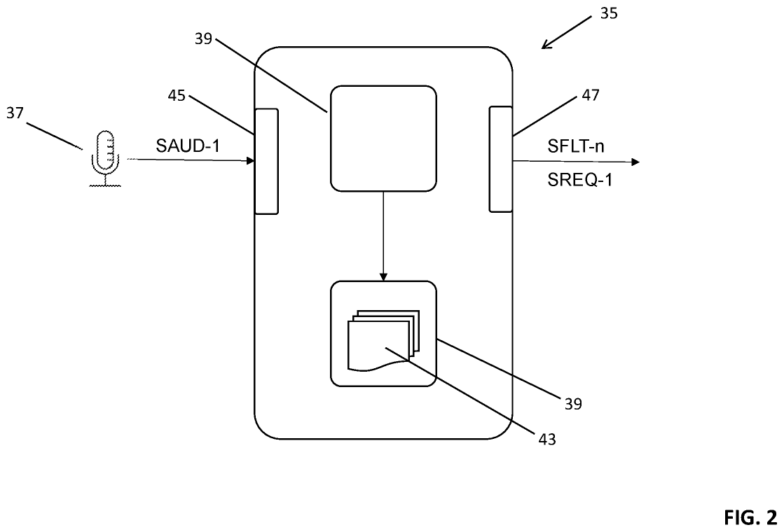

As shown in FIG. 2, the monitoring system controller 35 comprises at least one electronic processor 39 and a system memory 41. A set of instructions 43 is provided for controlling operation of the at least one electronic processor 39. The instructions 43 may, for example, be stored on the system memory 41. When executed by the at least one electronic processor 39, the instructions cause the at least one electronic processor 39 to perform the method(s) described herein. The monitoring system controller 35 comprises at least one input 45 and at least one output 47. The at least one input 45 is configured to receive the audio signal SAUD-1 from the microphone 37. In the present embodiment, the at least one input 45 is configured to receive the speed control signal SSPD-1 from the pump controller 23 indicating the operating speed of the drive motor 5 (or a target operating speed of the drive motor 5). In a variant, the at least one input 45 may receive a signal indicating a rotational speed of the drive shaft 7, for example from a shaft speed sensor (not shown). In a further variant, the monitoring system controller may analyse the audio signal SAUD-1 to determine an operating speed of the vacuum pump 3. The at least one output 47 is configured to output at least one fault condition signal SFLT-n. The least one fault condition signal SFLT-n may prompt generation of an alert, for example an audible alert and/or visible alert. The at least one fault condition signal SFLT-n may indicate a fault type and/or a fault severity rating. A first fault condition signal SFLT-1 may indicate a first fault condition; and a second fault condition signal SFLT-2 may indicate a second fault condition. The least one fault condition signal SFLT-n may be output to the pump controller 23, for example reduce an operating speed of the vacuum pump 3 or to initiate a shut-down procedure. In the present embodiment, the at least one output 47 is configured also to output a speed request signal SREQ-1 to the pump controller 23. The speed request signal SREQ-1 comprises a request to control the operating speed of the vacuum pump 5. For example, the speed request signal SREQ-1 may comprise a request to increase or decrease the operating speed for the vacuum pump 5; and/or may comprise a request for a target operating speed for the vacuum pump 5.

The at least one electronic processor 39 is configured to process the audio signal SAUD-1. The processing of the audio signal SAUD-1 is performed at least substantially in real time. The audio signal SAUD-1 output from the microphone 37 is in a time domain. The at least one electronic processor 39 is configured to transform the audio signal SAUD-1 to a frequency domain. The analysis of the audio signal SAUD-1 may thereby be performed with respect to frequency (rather than time). The frequency domain provides a quantitative indication of how much of the audio signal SAUD-1 occurs at each frequency. In the present embodiment the at least one electronic processor 39 is configured to apply a transform, such as a Fourier transform, to decompose the audio signal SAUD-1 into a plurality of frequency components. The electronic processor 39 could, for example, implement a fast Fourier transform algorithm to determine a discrete Fourier transform of the audio signal SAUD-1. Each frequency component may comprise a sine wave frequency component. A spectrum of the frequency components forms a frequency domain representation of the audio signal SAUD-1. The frequency domain representation comprises information about the frequency content of the audio signal SAUD-1. The magnitude of the frequency components provide an indication of a relative strength of the frequency components. Other transforms may be used to transform the audio signal SAUD-1.

The at least one electronic processor 39 is configured to analyse the frequency domain representation to identify one or more fault condition frequency component. The or each fault condition frequency component is indicative of a fault condition in the vacuum pump 3. The or each fault condition frequency component is an identifiable frequency component within the frequency domain representation which is characteristic of a particular fault condition. The fault condition frequency component corresponds to the audio signature of a particular fault condition. By identifying the fault condition frequency component, the pump monitoring system 1 can identify (or predict occurrence of) the corresponding fault condition. The or each fault condition frequency component is generally in the form of a peak in the frequency domain representation. The or each fault condition frequency component comprises a magnitude which is greater than a predefined magnitude value. Alternatively, or in addition, the or each fault condition frequency component may occur at a predefined frequency or within a predefined frequency range in the frequency domain representation. The frequency range may, for example, be defined by an upper frequency value and/or a lower frequency value. The at least one electronic processor 39 is configured to identify the presence or absence of the or each fault condition frequency component in the frequency domain representation. In particular, the at least one electronic processor 39 is configured to identify a frequency component occurring at a predefined frequency (or within a predefined frequency range) and having a magnitude greater than the predefined magnitude value. The at least one electronic processor 39 may apply a filter to the frequency domain representation to reduce or remove frequency components which are not associated with fault conditions. For example, the at least one electronic processor 39 may apply a filter to reduce or remove background noise. The frequency domain representation may optionally be output to a display device, such as a Liquid Crystal Display (LCD). A graphical representation of the frequency domain representation may be displayed to facilitate analysis by an operator. However, it will be understood that it is not essential that the frequency domain representation is displayed. The at least one electronic processor 39 may monitor the operation of the vacuum pump 3 to identify a fault condition automatically.

The one or more fault condition frequency component is predefined in the present embodiment. The fault condition frequency component may be identified by experimental analysis, for example by analysing the sound waves emitted by a vacuum pump having one or more known fault condition. A comparison of the frequency domain representation for a vacuum pump with a known fault condition with the frequency domain representation for a vacuum pump without the fault condition (under similar operating conditions) may enable identification of a frequency component associated with a particular fault condition. The identified frequency component can be used to define the fault condition frequency component associated with that fault condition. This process may be repeated to identify a plurality of frequency components associated with different fault conditions. The one or more fault condition frequency component could be determined dynamically, for example by correlating frequency components in the frequency domain representation to service or maintenance data for the vacuum pump 3. The fault condition frequency component(s) may be unique to a particular type or model of vacuum pump. However, it is envisaged that the fault condition frequency component(s) may be applicable to a plurality of different vacuum pumps of a similar type or configuration.

In the present embodiment, the at least one electronic processor 39 is configured to identify the presence of one or more of a plurality of fault condition frequency components. The at least one electronic processor 39 may, for example, identify the presence of a first fault condition frequency component and a second fault condition frequency component. The pump monitoring system 1 according to the present invention may identify one or more of the following fault conditions: (i) a bearing cage defect; (ii) an outer race defect; (iii) a rolling element defect; and (iv) an inner race defect. A fault condition frequency component can be defined for each of these fault conditions. The analysis of the frequency domain to identify the fault condition frequency components will now be described.

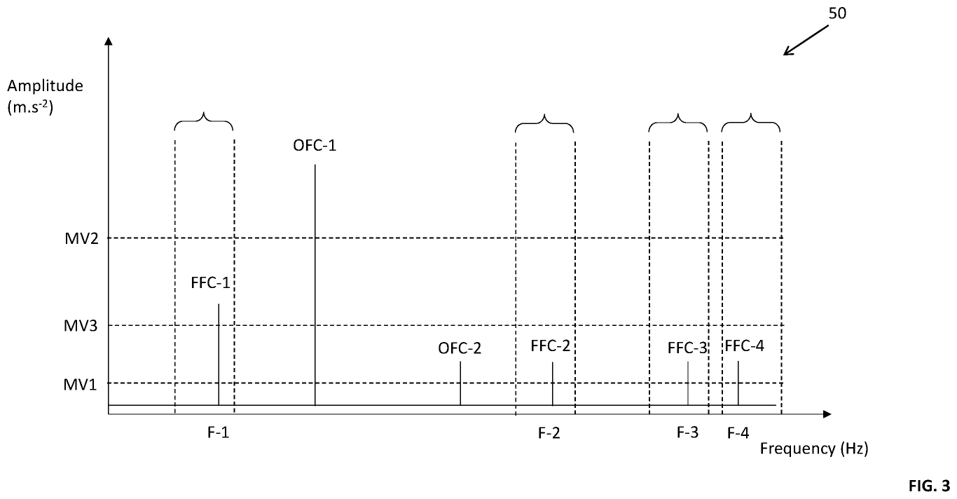

A graph 50 illustrating the frequency domain representation of a vacuum pump 3 is illustrated in FIG. 3. The graph 50 represents the frequency (Hz) on the X-axis and the amplitude (m/s²) of the frequency components. The graph 50 comprises a plurality of frequency components which are identifiable within the frequency domain representation of the audio signal SAUD-1 captured by the microphone 37. The frequency components comprise operational frequency components OFC-n which are associated with normal operation of the vacuum pump 3; and fault condition frequency components FFC-n which are associated with fault conditions in the vacuum pump 3. The operational frequency components OFC-n and the fault condition frequency components FFC-n are each defined by one or more frequency component identifier. The frequency component identifiers comprise one or more of the following: a magnitude of the frequency component; a magnitude range of the frequency component; a frequency at which the frequency component occurs; and a frequency range in which the frequency component occurs. The magnitude range of the frequency component may be defined with reference to a lower magnitude value and/or an upper magnitude value. The frequency range of the frequency component may be defined with reference to a lower frequency value and/or an upper frequency value.

The at least one electronic processor 39 is configured to identify the presence or absence of each operational frequency component OFC-n within the frequency domain representation; and the presence or absence of each fault condition frequency component FFC-n within the frequency domain representation. The at least one electronic processor 39 identifies the operational frequency component(s) OFC-n and the fault condition frequency component(s) FFC-n in dependence on the one or more frequency component identifier associated with the respective operational and fault condition frequency components. The one or more frequency component identifier in the present embodiment comprise the frequency of the frequency component; and the magnitude of the frequency component. The one or more frequency component identifier are defined to enable identification of each frequency component. One or more of the operational frequency components OFC-n can generally be identified in the frequency domain representation when the vacuum pump 3 is operating. It will be understood that the fault condition frequency components FFC-n may not be identified in the frequency domain representation depending on the condition of the vacuum pump 3. If the vacuum pump 3 is operating without any fault conditions, the frequency domain representation would not include any of the fault condition frequency components FFC-n. Similarly, if the vacuum pump 3 is operating with one or more fault condition, the frequency domain representation will include only the fault condition frequency component(s) FFC-n indicative of each of the one or more fault condition.

The operational frequency components OFC-n represented in the graph 50 shown in FIG. 2 will now be described. A first operational frequency component OFC-1 is associated with the operating speed of the vacuum pump 3 (corresponding to the rotational speed of the drive shaft 7). The first operational frequency component OFC-1 occurs at a first operational frequency. The first operational frequency is approximately 1000 Hz in the present example. The frequency of the first operational frequency component OFC-1 is dependent on the operating speed of the vacuum pump 3. The at least one electronic processor 39 could optionally be configured to determine an operating speed of the vacuum pump 3 in dependence on the frequency of the first operational frequency component OFC-1. The at least one electronic processor 39 is configured to identify the first operational frequency component OFC-1 by identifying a frequency component having a magnitude greater than a predefined second magnitude value MV-2. A second operational frequency component OFC-2 is associated with the spin frequency of the bearing elements 15 in the bearing assembly 9. The second operational frequency component OFC-2 occurs at a second operational frequency. The second operational frequency is approximately 4322 Hz in the present example. The at least one electronic processor 39 is configured to identify the second operational frequency component OFC-2 by identifying a frequency component having a frequency in a predefined range, for example in range 4300 Hz to 4400 Hz. The second operational frequency may also be related to the operating speed of the vacuum pump 3. A change in the operating speed of the vacuum pump 3 may also modify the second operational frequency of the second operational frequency component. It will be understood that the frequencies cited herein for the operational frequency components OFC-n are by way of example only. A frequency range of 100 Hz is indicated herein to identify each of the operational frequency components OFC-n. The frequency range may be increased, for example to a range of 200 Hz; or may be decreased, for example to a range of 50 Hz.

The fault condition frequency components FFC-n represented in the graph 50 shown in FIG. 2 will now be described. A first fault condition frequency component FFC-1 is associated with a cage defect. The first fault condition frequency component FFC-1 occurs at a first frequency F1. The first frequency F1 is approximately 382 Hz in the present example. The at least one electronic processor 39 is configured to identify the first fault condition frequency component FFC-1 by identifying a frequency component having a magnitude greater than a predefined third magnitude value MV-3 and/or having a frequency in a first frequency range. The first frequency range is 300 Hz to 500 Hz in the present example. A second fault condition frequency component FFC-2 is associated with a defect or fault in the outer race 13 of the bearing assembly 9. The second fault condition frequency component FFC-2 occurs at a second frequency F2. The second frequency F2 is approximately 2677 Hz in the present example. The at least one electronic processor 39 is configured to identify the second fault condition frequency component FFC-2 by identifying a frequency component having a frequency in a second frequency range. The second frequency range is 2600 Hz to 2700 Hz in the present example. A third fault condition frequency component FFC-3 is associated with a defect or fault in the bearing (rolling) element 15 of the bearing assembly 9. The third fault condition frequency component FFC-3 occurs at a third frequency F3. The third frequency F3 is approximately 3779 Hz in the present example. The at least one electronic processor 39 is configured to identify the third fault condition frequency component FFC-3 by identifying a frequency component having a frequency in a third frequency range. The third frequency range is range 3700 Hz to 3800 Hz in the present example. A fourth fault condition frequency component FFC-4 is associated with a defect or fault in the inner race 11 of the bearing assembly 9. The fourth fault condition frequency component FFC-4 occurs at a fourth frequency F4. The fourth frequency is approximately 4322 Hz in the present example. The at least one electronic processor 39 is configured to identify the fourth fault condition frequency component FFC-4 by identifying a frequency component having a frequency in a fourth frequency range. The fourth frequency range is 4300 Hz to 4400 Hz in the present example. It will be understood that the frequencies cited herein for the fault condition frequency components FFC-n are by way of example only. A frequency range of 100 Hz is indicated herein to identify each of the fault condition frequency components FFC-n. The frequency range may be increased, for example to a range of 200 Hz; or may be decreased, for example to a range of 50 Hz.

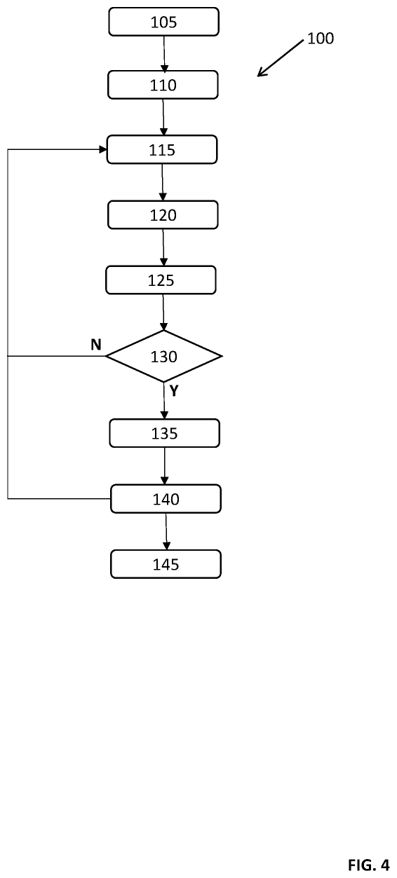

The operation of the pump monitoring system 1 will now be described with reference to a first block diagram 100 shown in FIG. 4. The pump monitoring system 1 and the vacuum pump 3 are activated (BLOCK 105). The microphone 37 generates an audio signal SAUD-1 indicative of sound waves generated by the vacuum pump 3 (BLOCK 110). The audio signal SAUD-1 is output to the monitoring system controller 35 which converts the audio signal SAUD-1 from a time domain to a frequency domain (BLOCK 115). The monitoring system controller 35 analyses the resulting frequency domain representation (BLOCK 120). The monitoring system controller 35 identifies frequency components in the frequency domain representation (BLOCK 125). The frequency components may be identified as those components having a magnitude greater than a predefined first magnitude value MV-1. A check is performed to determine if one or more of the identified frequency component corresponds to one of the predefined fault condition frequency components indicative of a fault condition (BLOCK 130). If the identified frequency components do not correspond to one of the predefined fault condition frequency components FFC-n, the pump monitoring system 1 continues to analyse the frequency domain representation (BLOCK 115). If one or more of the identified frequency components does correspond to one of the predefined fault condition frequency component FFC-n, the pump monitoring system 1 generates a fault condition signal SFLT-n (BLOCK 135). The monitoring system controller 35 may identify a type of the fault condition signal SFLT-n, for example in dependence on the frequency of the fault condition frequency component FFC-n. The fault condition signal SFLT-n may indicate the type of the fault condition. An alert or notification is generated in dependence on the fault condition signal SFLT-n (BLOCK 140). The pump monitoring system 1 continues to analyse the frequency domain representation (BLOCK 115). The pump monitoring system 1 and the vacuum pump 3 are deactivated (BLOCK 145).

The pump monitoring system 1 may be configured to identify the fault condition frequency components FFC-n in dependence on the operating speed of the vacuum pump 3. The frequency at which the fault condition frequency components FFC-n occur in the frequency domain representation may vary depending on an operating speed of the vacuum pump 3. The magnitude of the fault condition frequency components FFC-n may vary depending on the operating speed of the vacuum pump 3. The frequency ranges associated with each fault condition frequency components FFC-n may be defined to account for any such variations. The frequency of each fault condition frequency components FFC-n may be modified in dependence on the operating speed of the vacuum pump 3. The upper value and/or the lower values defining each frequency range may be modified in dependence on the operating speed of the vacuum pump 3. The pump monitoring system 1 may determine the operating speed of the vacuum pump 3 with reference to the frequency at which the first operating frequency component OFC-1 is identified. Alternatively, or in addition, the pump monitoring system 1 may be determined by communicating with the pump controller 23. The pump monitoring system 1 may monitor changes in the frequency of the fault condition frequency components FFC-n as the operating speed of the vacuum pump 3 changes, for example as the speed increases during a ramp-up process, or as the speed decreases during a ramp-down process. The predefined magnitude values MV-n applied to identify the frequency components may be adjusted in dependence on the operating speed of the vacuum pump 3.

It has been recognised that changes in the frequency and/or magnitude of the fault condition frequency components FFC-n at different operating speeds of the vacuum pump 3 may be used to validate the identification of a fault condition. In a variant of the pump monitoring system 1 described herein, the monitoring system controller 35 may output a speed request signal SREQ-1 to the pump controller 23 to control the operating speed of the vacuum pump 5. The speed request signal SREQ-1 may comprise a request to increase or decrease the operating speed for the vacuum pump 5. The pump monitoring system 1 may monitor changes in the frequency and/or magnitude of the fault condition frequency components FFC-n as the operating speed of the vacuum pump 3 changes. At least in certain embodiments, the accuracy of detecting the fault condition may be improved by tracking changes in the frequency of the characteristic fault condition FFC-n as the operating speed of the vacuum pump 3 changes. Alternatively, or in addition, the speed request signal SREQ-1 may comprise a request to set a target operating speed for the vacuum pump 5. The pump monitoring system 1 may monitor the frequency of the fault condition frequency components FFC-n when the operating speed of the vacuum pump 3 is at the target operating speed. At least in certain embodiments, the accuracy of detecting the fault condition may be improved when the vacuum pump 3 is operating at a target operating speed. The target operating speed may, for example, be defined to correspond to the operating speed used for the collection of reference data.

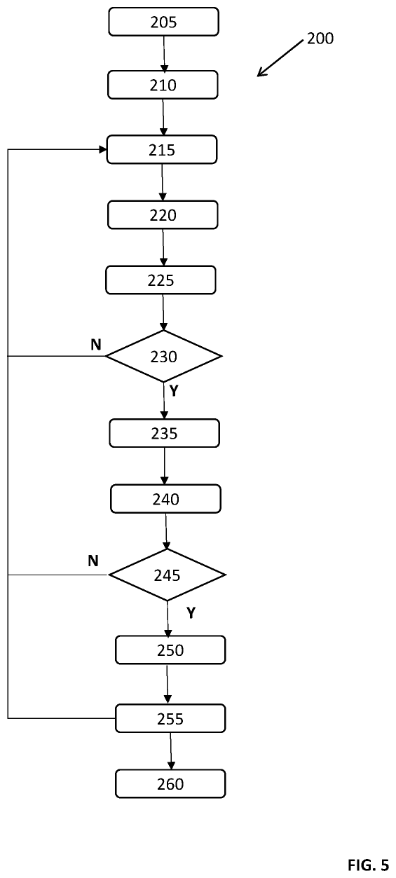

The operation of the pump monitoring system 1 in accordance with this variant will now be described with reference to a second block diagram 200 shown in FIG. 5. The pump monitoring system 1 and the vacuum pump 3 are activated (BLOCK 205). The microphone 37 generates an audio signal SAUD-1 indicative of sound waves generated by the vacuum pump 3 (BLOCK 210). The audio signal SAUD-1 is output to the monitoring system controller 35 which converts the audio signal SAUD-1 from a time domain to a frequency domain (BLOCK 215). The monitoring system controller 35 analyses the resulting frequency domain representation (BLOCK 220). The monitoring system controller 35 identifies frequency components in the frequency domain representation (BLOCK 225). The frequency components may be identified as those components having a magnitude greater than a predefined first magnitude value MV-1. A check is performed to determine if one or more of the identified frequency component corresponds to one of the predefined fault condition frequency components indicative of a fault condition (BLOCK 230). If the identified frequency components do not correspond to one of the predefined fault condition frequency components FFC-n, the pump monitoring system 1 continues to analyse the frequency domain representation (BLOCK 215). If one or more of the identified frequency components does correspond to one of the predefined fault condition frequency component FFC-n, the pump monitoring system 1 outputs a speed request signal SREQ-1 to the pump controller 23 to request a change in the operating speed of the vacuum pump 5 (BLOCK 235). The speed request signal SREQ-1 may comprise a request to increase or decrease the operating speed of the vacuum pump 5. The monitoring system controller 35 analyses the frequency domain representation to identify changes in the frequency of the fault condition frequency component FFC-n as the operating speed of the vacuum pump 3 changes (BLOCK 240). A check is performed to determine if the changes in the operating speed of the vacuum pump 3 result in a predicted (expected) change in the one or more frequency component identifier of the fault condition frequency component FFC-n (BLOCK 245). The predicted change may comprise or consist of an increase or a decrease in the frequency and/or magnitude of the frequency component. The monitoring system controller 35 may monitor changes in the frequency and/or the magnitude of the frequency component in dependence on changes in the operating speed of the vacuum pump 3. Alternatively, or in addition, the predicted change may comprise or consist of a rate of change of the frequency component. The monitoring system controller 35 may monitor a rate of change of the frequency of the fault condition frequency component FFC-n in dependence on a change in the operating speed of the vacuum pump 3. By way of example, the frequency of the fault condition frequency component FFC-n may increase as the operating speed increases; or the frequency of the fault condition frequency component FFC-n may decrease as the operating speed decreases. If the expected changes in the one or more frequency component identifier changes are identified, the pump monitoring system 1 generates a fault condition signal SFLT-n (BLOCK 250). If the expected changes in the one or more frequency component identifier changes are not identified, the pump monitoring system 1 continues to analyse the frequency domain representation (BLOCK 215). An alert or notification is generated in dependence on the fault condition signal SFLT-n (BLOCK 255). The pump monitoring system 1 continues to analyse the frequency domain representation (BLOCK 215). The pump monitoring system 1 and the vacuum pump 3 are deactivated (BLOCK 260).

The monitoring system controller 35 may optionally grade or classify the fault condition in dependence on the magnitude of the fault condition frequency component FFC-n. If the magnitude of the fault condition frequency component FFC-n is greater than a first value, the monitoring system controller 35 may classify the fault condition as having a first classification, for example to prompt maintenance at the next service interval. Alternatively, or in addition, if the magnitude of the fault condition frequency component FFC-n is greater than a second value, the monitoring system controller 35 may classify the fault condition as having a second classification, for example to prompt maintenance as soon as possible. Alternatively, or in addition, if the magnitude of the fault condition frequency component FFC-n is greater than a third value, the monitoring system controller 35 may classify the fault condition as having a third classification, for example to shut down the vacuum pump 3. The monitoring system controller 35 may grade or classify the fault conditions in dependence on the frequency domain representation of the audio signal and/or the temporal domain representation of the audio signal.

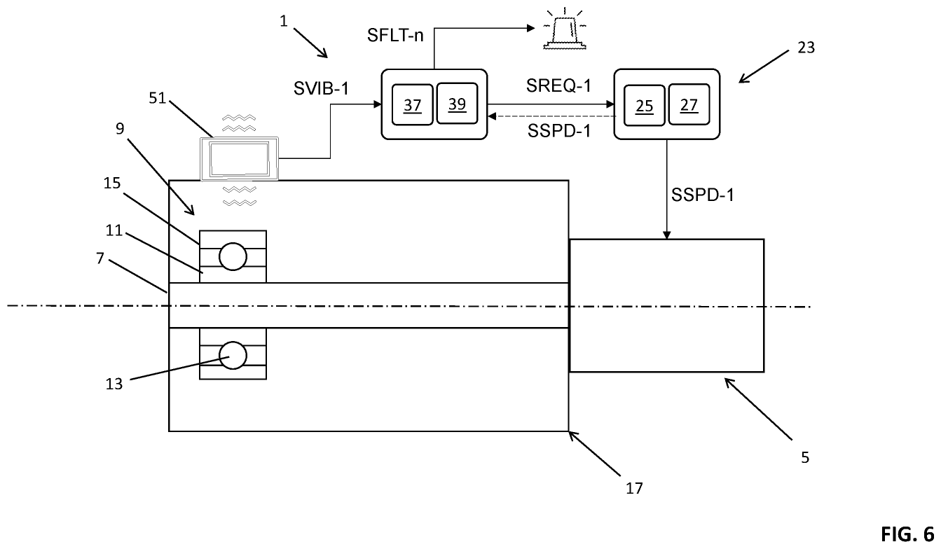

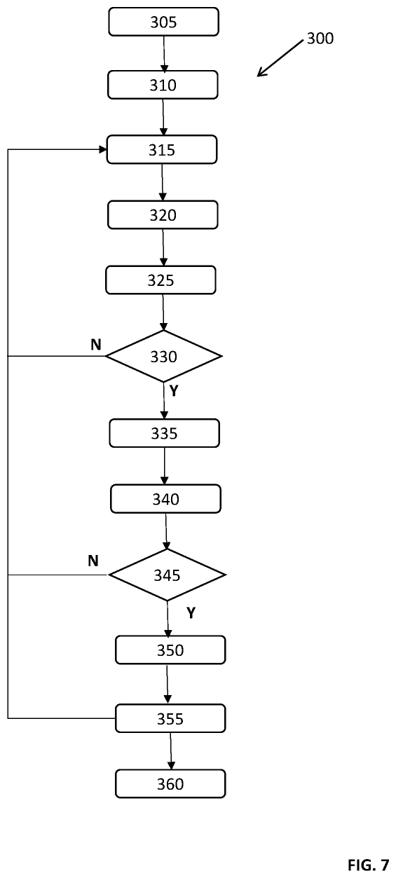

The above arrangement in which the monitoring system controller 35 outputs a speed request signal SREQ-1 to control the operation speed of the vacuum pump 5 can be utilised in a pump monitoring system which employs different sensors to monitor the vacuum pump 3. For example, this control system and method may be employed in a pump monitoring system 1 which utilises a vibration sensor, such as an accelerometer. An embodiment of the pump monitoring system 1 comprising a vibration sensor 51 will now be described with reference to FIGS. 6 and 7. Like reference numerals are used for like components in this embodiment. It will be understood that the vibration sensor 51 may be used instead of or in addition to the microphone 37.

The pump monitoring system 1 according to the present embodiment is configured to monitor operation of a vacuum pump 3. The configuration of the vacuum pump 3 is unchanged from the arrangement described herein with reference to FIG. 1. The vacuum pump 3 comprises a drive motor 5 operative to rotate a drive shaft 7. The drive shaft 7 is supported by at least one bearing assembly 9 comprising an inner race 11, an outer race 13; a plurality of bearing (rolling) elements 15 disposed between the inner and outer races 11, 13; and a bearing cage (not shown) for holding the bearing elements 15. The inner race 11 is fixed to and rotates with the drive shaft 7. The outer race 13 is fixedly mounted to a bearing or pump housing (denoted generally by the reference numeral 17). The pump monitoring system 1 is operative to identify fault conditions associated with the drive shaft 7 and/or the bearing assembly 9. The pump monitoring system 1 may identify an imbalance in the drive shaft 7, for example caused by the accumulation of deposits from the process gas. The pump monitoring system 1 may identify a fault condition in the bearing assembly 9 caused by wear. In certain embodiments, the pump monitoring system 1 may differentiate between wear on one or more of the inner race 11, the outer race 13 and the bearing elements 15.

A pump controller 23 is provided for controlling operation of the vacuum pump 3. The pump controller 23 is the same as the arrangement illustrated in FIG. 2. Again, like reference numerals are used for like components. The pump controller 23 comprises an electronic processor 25 and a system memory 27. The electronic processor 25 is configured to output a speed control signal SSPD-1 to control an operating speed of the drive motor 5. The speed control signal SSPD-1 may be output from the pump controller 23 to the pump monitoring system 1.

The pump monitoring system 1 comprises a monitoring system controller 35 and an accelerometer 51 for detecting vibrations. The accelerometer 51 is configured to detect vibrations generated by the operation of the vacuum pump 3. The vibrations propagate through the structure of the vacuum pump 3, for example through the pump housing 17, and are detected by the accelerometer 51. The accelerometer 51 is configured to generate a vibration signal SVIB-1 representing the vibrations. The vibration signal SVIB-1 is output to the monitoring system controller 35 to be processed. The accelerometer 51 is fixedly mounted to the vacuum pump 3, for example fastened to the pump housing 17.

The monitoring system controller 35 comprises at least one electronic processor 39 and a system memory 41. A set of instructions 43 is provided for controlling operation of the at least one electronic processor 39. The instructions 43 may, for example, be stored on the system memory 41. When executed by the at least one electronic processor 39, the instructions cause the at least one electronic processor 39 to perform the method(s) described herein. The monitoring system controller 35 comprises at least one input 45 and at least one output 47. The at least one input 45 is configured to receive the vibration signal SVIB-1 from the accelerometer 51. In the present embodiment, the at least one input 45 is configured to receive the speed control signal SSPD-1 from the pump controller 23 indicating the operating speed of the drive motor 5 (or a target operating speed of the drive motor 5). In a variant, the at least one input 45 may receive a signal indicating a rotational speed of the drive shaft 7, for example from a shaft speed sensor (not shown). In a further variant, the monitoring system controller may analyse the vibration signal SVIB-1 to determine an operating speed of the vacuum pump 3. The at least one output 47 is configured to output at least one fault condition signal SFLT-n. The least one fault condition signal SFLT-n may prompt generation of an alert, for example an audible alert and/or visible alert. The at least one fault condition signal SFLT-n may indicate a fault type and/or a fault severity rating. A first fault condition signal SFLT-1 may indicate a first fault condition; and a second fault condition signal SFLT-2 may indicate a second fault condition. The least one fault condition signal SFLT-n may be output to the pump controller 23, for example reduce an operating speed of the vacuum pump 3 or to initiate a shut-down procedure. In the present embodiment, the at least one output 47 is configured also to output a speed request signal SREQ-1 to the pump controller 23. The speed request signal SREQ-1 comprises a request to control the operating speed of the vacuum pump 5. For example, the speed request signal SREQ-1 may comprise a request to increase or decrease the operating speed for the vacuum pump 5; and/or may comprise a request for a target operating speed for the vacuum pump 5.

The at least one electronic processor 39 is configured to process the vibration signal SVIB-1. The processing of the vibration signal SVIB-1 is performed at least substantially in real time. The vibration signal SVIB-1 output from the accelerometer 51 is in a time domain. The at least one electronic processor 39 is configured to transform the vibration signal SVIB-1 to a frequency domain. The analysis of the vibration signal SVIB-1 may thereby be performed with respect to frequency (rather than time). The frequency domain provides a quantitative indication of how much of the vibration signal SVIB-1 occurs at each frequency. In the present embodiment the at least one electronic processor 39 is configured to apply a transform, such as a Fourier transform, to decompose the vibration signal SVIB-1 into a plurality of frequency components. The electronic processor 39 could, for example, implement a fast Fourier transform algorithm to determine a discrete Fourier transform of the vibration signal SVIB-1. Each frequency component may comprise a sine wave frequency component. A spectrum of the frequency components forms a frequency domain representation of the vibration signal SVIB-1. The frequency domain representation comprises information about the frequency content of the vibration signal SVIB-1. The magnitude of the frequency components provide an indication of a relative strength of the frequency components. Other transforms may be used to transform the vibration signal SVIB-1.

The at least one electronic processor 39 is configured to analyse the frequency domain representation to identify one or more fault condition frequency component. The or each fault condition frequency component is indicative of a fault condition in the vacuum pump 3. The or each fault condition frequency component is an identifiable frequency component within the frequency domain representation which is characteristic of a particular fault condition. The fault condition frequency component corresponds to the vibration signature of a particular fault condition. By identifying the fault condition frequency component, the pump monitoring system 1 can identify (or predict occurrence of) the corresponding fault condition. The or each fault condition frequency component is generally in the form of a peak in the frequency domain representation. The or each fault condition frequency component comprises a magnitude which is greater than a predefined magnitude value. Alternatively, or in addition, the or each fault condition frequency component may occur at a predefined frequency or within a predefined frequency range in the frequency domain representation. The frequency range may, for example, be defined by an upper frequency value and/or a lower frequency value. The at least one electronic processor 39 is configured to identify the presence or absence of the or each fault condition frequency component in the frequency domain representation. In particular, the at least one electronic processor 39 is configured to identify a frequency component occurring at a predefined frequency (or within a predefined frequency range) and having a magnitude greater than the predefined magnitude value. The at least one electronic processor 39 may apply a filter to the frequency domain representation to reduce or remove frequency components which are not associated with fault conditions. For example, the at least one electronic processor 39 may apply a filter to reduce or remove background noise. The frequency domain representation may optionally be output to a display device, such as a Liquid Crystal Display (LCD). A graphical representation of the frequency domain representation may be displayed to facilitate analysis by an operator. However, it will be understood that it is not essential that the frequency domain representation is displayed. The at least one electronic processor 39 may monitor the operation of the vacuum pump 3 to identify a fault condition automatically.

The frequency and/or magnitude of the fault condition frequency components FFC-n at different operating speeds of the vacuum pump 3 is used to validate the identification of a fault condition. The monitoring system controller 35 in the present embodiment is configured to output a speed request signal SREQ-1 to the pump controller 23 to control the operating speed of the vacuum pump 5. The speed request signal SREQ-1 may comprise a request to increase or decrease the operating speed for the vacuum pump 5. The pump monitoring system 1 may monitor changes in the frequency and/or magnitude of the fault condition frequency components FFC-n as the operating speed of the vacuum pump 3 changes. At least in certain embodiments, the accuracy of detecting the fault condition may be improved by tracking changes in the frequency of the characteristic fault condition FFC-n as the operating speed of the vacuum pump 3 changes. Alternatively, or in addition, the speed request signal SREQ-1 may comprise a request to set a target operating speed for the vacuum pump 5. The pump monitoring system 1 may monitor the frequency of the fault condition frequency components FFC-n when the operating speed of the vacuum pump 3 is at the target operating speed. At least in certain embodiments, the accuracy of detecting the fault condition may be improved when the vacuum pump 3 is operating at a target operating speed. The target operating speed may, for example, be defined to correspond to the operating speed used for the collection of reference data.

The operation of the pump monitoring system 1 in accordance with this variant will now be described with reference to a third block diagram 300 shown in FIG. 7. The pump monitoring system 1 and the vacuum pump 3 are activated (BLOCK 305). The accelerometer 51 generates a vibration signal SVIB-1 indicative of vibrations generated by the vacuum pump 3 (BLOCK 310). The vibration signal SVIB-1 is output to the monitoring system controller 35 which converts the vibration signal SVIB-1 from a time domain to a frequency domain (BLOCK 315). The monitoring system controller 35 analyses the resulting frequency domain representation (BLOCK 320). The monitoring system controller 35 identifies frequency components in the frequency domain representation (BLOCK 325). The frequency components may be identified as those components having a magnitude greater than a predefined first magnitude value MV-1. A check is performed to determine if one or more of the identified frequency component corresponds to one of the predefined fault condition frequency components indicative of a fault condition (BLOCK 330). If the identified frequency components do not correspond to one of the predefined fault condition frequency components FFC-n, the pump monitoring system 1 continues to analyse the frequency domain representation (BLOCK 315). If one or more of the identified frequency components does correspond to one of the predefined fault condition frequency component FFC-n, the pump monitoring system 1 outputs a speed request signal SREQ-1 to the pump controller 33 to request a change in the operating speed of the vacuum pump 5 (BLOCK 335). The speed request signal SREQ-1 may comprise a request to increase or decrease the operating speed of the vacuum pump 5. The monitoring system controller 35 may monitor changes in the frequency and/or the magnitude of the frequency component in dependence on changes in the operating speed of the vacuum pump 3. Alternatively, or in addition, the predicted change may comprise or consist of a rate of change of the frequency component. The monitoring system controller 35 may monitor a rate of change of the frequency of the fault condition frequency component FFC-n in dependence on a change in the operating speed of the vacuum pump 3. The monitoring system controller 35 analyses the frequency domain representation to identify changes in the frequency of the fault condition frequency component FFC-n as the operating speed of the vacuum pump 3 changes (BLOCK 340). A check is performed to determine If the changes in the operating speed of the vacuum pump 3 result in a predicted (expected) change in the one or more frequency component identifier of the fault condition frequency component FFC-n (BLOCK 345). The predicted change may comprise an increase or a decrease in the frequency and/or magnitude of the frequency component. By way of example, the frequency of the fault condition frequency component FFC-n may increase as the operating speed increases; or the frequency of the fault condition frequency component FFC-n may decrease as the operating speed decreases. If the expected changes in the one or more frequency component identifier changes are identified, the pump monitoring system 1 generates a fault condition signal SFLT-n (BLOCK 350). If the expected changes in the one or more frequency component identifier changes are not identified, the pump monitoring system 1 continues to analyse the frequency domain representation (BLOCK 315). An alert or notification is generated in dependence on the fault condition signal SFLT-n (BLOCK 355). The pump monitoring system 1 continues to analyse the frequency domain representation (BLOCK 315). The pump monitoring system 1 and the vacuum pump 3 are deactivated (BLOCK 360).

It will be appreciated that various changes and modifications can be made to the present invention without departing from the scope of the present application.

The analysis of the audio signal captured by the microphone 37 may be combined with other measurement data relating to the vacuum pump 3. For example, a temperature sensor may generate a thermal signal indicating an operating temperature of the vacuum pump 3. The thermal signal may be analysed in conjunction with the audio signal SAUD-1 to monitor operation of the vacuum pump 3 and identify one or more fault condition. Alternatively, or in addition, a pressure sensor may be provided to measure an operating pressure of the vacuum pump 3, for example at a pump inlet or a pump outlet.

The pump monitoring system 1 has been described herein with reference to a single microphone 37. It will be understood that more than one microphone 37 may be employed.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A pump monitoring system for identifying a fault condition in a vacuum pump; the pump monitoring system comprising a controller and a microphone for detecting sound waves; the controller being configured to:
receive an audio signal from the microphone representing sound waves generated by the vacuum pump;
process the received audio signal generate a frequency domain representation of the audio signal;
analyse the frequency domain representation of the audio signal to identify at least one fault condition frequency component indicative of a fault condition; and
output a fault condition signal to identify the fault condition in dependence on the identification of the at least one fault condition frequency component.

2-3. (canceled)

4. The pump monitoring system as claimed in claim 1, wherein the controller is configured to determine an operating speed of the vacuum pump; and the at least one fault condition frequency component identified in dependence on the determined operating speed of the vacuum pump.

5. The pump monitoring system as claimed in claim 4, wherein the controller is configured to identify the at least one fault condition frequency component during steady-state operation of the vacuum pump.

6. The pump monitoring system as claimed in claim 4, wherein the controller is configured to identify the at least one fault condition frequency component as the operating speed of the vacuum pump increases or decreases.

7. The pump monitoring system as claimed in claim 1, wherein the controller is configured to output a request to change an operating speed of the vacuum pump; and the controller is configured to monitor a change in the at least one fault condition frequency component in dependence on the change in the operating speed of the vacuum pump.

8. The pump monitoring system as claimed in claim 1, wherein the controller is configured to determine an operating load on the vacuum pump; and the at least one fault condition frequency component identified in dependence on the operating load of the vacuum pump.

9. The pump monitoring system as claimed in claim 1, wherein the or each fault condition frequency component comprises one or more frequency component identifier, the controller being configured to identify the at least one fault condition frequency component in dependence on the identification of the one or more frequency component identifier in the frequency domain representation.

10. The pump monitoring system as claimed in claim 9, wherein the one or more frequency component identifier comprises a frequency or a frequency range of the or each fault condition frequency component.

11. The pump monitoring system as claimed in claim 9, wherein the one or more frequency component identifier comprises a magnitude or a magnitude range of the or each fault condition frequency component.

12. The pump monitoring system as claimed in claim 9, wherein the one or more frequency component identifier is defined with respect to an operating speed of the vacuum pump.

13. (canceled)

14. A method of identifying a fault condition in a vacuum pump; the method comprising:
receive an audio signal representing sound waves generated by the vacuum pump;
converting the audio signal to a frequency domain;
analysing the frequency domain to identify at least one fault condition frequency component indicative of a fault condition; and
identifying the fault condition in dependence on the identification of the at least one fault condition frequency component.

15. The method as claimed in claim 14 comprising determining an operating speed of the vacuum pump; and identifying the at least one fault condition frequency component in dependence on the determined operating speed of the vacuum pump.

16. The method as claimed in claim 15 comprising identifying the at least one fault condition frequency component during steady-state operation of the vacuum pump.

17. The method as claimed in claim 15 comprising identifying the at least one fault condition frequency component as the operating speed of the vacuum pump increases or decreases.

18. The method as claimed in claim 14 comprising changing the operating speed of the vacuum pump; and monitoring changes in the at least one fault condition frequency component as the operating speed of the vacuum pump changes.

19. The method as claimed in claim 14 comprising determining an operating load on the vacuum pump; and identifying the at least one fault condition frequency component in dependence on the operating load of the vacuum pump.

20. The method as claimed in claim 14, wherein the or each fault condition frequency component comprises one or more frequency component identifier, the controller being configured to identify the at least one fault condition frequency component in dependence on the identification of the one or more frequency component identifier in the frequency domain representation.

21. The method as claimed in claim 20, wherein the one or more frequency component identifier comprises a frequency or a frequency range of the or each fault condition frequency component.

22. The method as claimed in claim 20, wherein the one or more frequency component identifier comprises a magnitude or a magnitude range of the or each fault condition frequency component.

23. The method as claimed in claim 20, wherein the one or more frequency component identifier is defined with respect to an operating speed of the vacuum pump.

24. (canceled)
